(19) United States
(12) Patent Application Publication
(10) Pub. No.: US 2011/0258303 A1
(43) Pub. Date: Oct. 20, 2011

(54) SYSTEM AND METHOD FOR PERSONAL DEVICE SHARING USING SOCIAL NETWORKS

(76) Inventors: Badri Nath, Edison, NJ (US); Liviu Iftode, Princeton, NJ (US); Pravin Shankar, Sunnyvale, CA (US); Lu Han, Piscataway, NJ (US)

(21) Appl. No.: 13/074,252

(22) Filed: Mar. 29, 2011

Related U.S. Application Data
(60) Provisional application No. 61/318,601, filed on Mar. 29, 2010.

(51) Int. Cl. G06F 15/16

(52) U.S. Cl. 709/223

(57) ABSTRACT

A system and method is disclosed which may comprise receiving, via a computing device, from a first user having a first personal device, a request for sharing access to a resource or a state of a second personal device of a second user, the first user and second user having an on-line social network relationship; and determining whether to grant sharing access to the one of the resource and the state of the second personal device of the second user. Determining whether to grant sharing access may be based, at least in part, upon the nature of the on-line social network relationship. The method and apparatus may comprise registering, via the computing device, an ownership link for a personal device and an owner having a certified identity within the social network; storing the ownership link; and utilizing the ownership link for determining whether to grant sharing access.

### CROSS-REFERENCE TO RELATED APPLICATIONS

The present application claims priority to U.S. Provisional Patent Application No. 61/318,601, filed on Mar. 29, 2010, entitled, SYSTEM AND METHOD FOR PERSONAL DEVICE SHARING USING SOCIAL NETWORKS, the disclosure of which is hereby incorporated by reference.

### FIELD OF THE INVENTION

The disclosed subject matter relates to sharing personal communication and computing device resources and functionalities over a network, e.g., through a social network.

### BACKGROUND OF THE INVENTION

Mobile phones and other communication-capable portable personal communication and computing devices, such as Blackberry®, IPod™, Droid™ and the like are among the most popular portable personal devices, with over four billion in use currently worldwide, and increasing rapidly (herein collectively “portable personal devices”). Other personal communication and computing devices, portable and otherwise, include Wii™ game controllers, in-car PCs, GPS devices, tablet PCs (e.g., iPad™) and TiVo® players (herein, collectively with “portable personal devices,” “personal devices”). These personal devices feature powerful processors and internet connectivity via, for example, 3G, 4G, and WiFi interfaces, and the like, making personal devices increasingly important as communications and computing platforms.

People tend to share their belongings with their friends. For example, people often share books and movies that they own with their friends, co-workers, relatives and the like (herein’ collectively “friends”). Carpooling is a common way in which people share, e.g., their cars with their friends, acquaintances and co-workers (herein collectively included within “friends”). With the growth of Online Social Networks (OSNs), such as, Facebook, LinkedIn, Twitter, Google Buzz, on-line personal blogs, etc., people have started sharing personal data, such as stories, experiences, friends, including an increasing cadre of so-called virtual friends, contacts, songs, pictures, videos, and the like (herein, collectively (“information”) with their friends, to whom, in many cases, they have become more connected than every before, using the network, such as using sites like Flickr and Youtube (herein collectively “on-line video sharing sites”). OSNs like those noted above, including, e.g., Facebook, LinkedIn, Twitter and Google Buzz (herein collectively with OSNs, “social networks”) also allow users to share their whereabouts, the news they learn, and the changes that occur in their lives, among other types of personal information.

Improvements in communications between personal devices have been discussed much in the art, including usability issues in home networking as discussed in Shehan, et al., “Home networking and HCI: what hath god wrought?”, Proceedings of the SIGCHI conference on Human factors in computing systems (2007), proposed improvements in the usability of device communication, such as is discussed in Allman, “Personal namespaces,” Proceedings of ACM SIGCOMM HotNets Workshop (2007) (personal namespaces as alternatives to device naming), Allman, et. al., “Relationship-oriented networking,” ICSI Networking Group Technical Report (2008), and MIT's Unmanaged Internet Architecture, as discussed in Ford, et al., “Persistent personal names for globally connected mobile devices,” Proceedings of the 7th USENIX Symposium on Operating Systems Design and Implementation (OSDI), (2006) and Ford, et al., “User-relative names for globally connected personal devices,” Proceedings of the 5th International Workshop on Peer-to-Peer Systems (IPTPS) (2006) (user-friendly architecture for naming, locating and routing between personal devices), and, finally Banks, et al., “Social links: integrating social networks with internet routing,” Proceedings of the ACM SIGCOMM workshop on large scale attack defense, pp. 121-128 (2007) (routing scheme that involves social networks between nodes on the internet). The disclosed subject matter in the present application, on the other hand, relates to enabling device sharing.

Systems and methods using models for remote device access have been proposed, e.g., as discussed in Hirofuchi, et al. “USB/IPA peripheral bus extension for device sharing over IP network,” Proceedings of USENIX Annual Technical Conference, FREENIX Track, pp. 47-60 (2005) (peripheral bus extension over a TCP/IP network to access a remote USB device in a homogeneous environment), XMPP protocol specification. http://xmpp.org/tech/overview.shtml (extended the architecture to support heterogeneous environments), Kong, et al., “Cameracast: Flexible access to remote video sensors,” Proceedings of Multimedia Computing and Networking (MMCN) (2007) and Kwon, et al., “Design and implementation of peripheral sharing mechanism on pervasive computing with heterogeneous environment,” Software Technologies for Embedded and Ubiquitous Systems, Volume 4761 (2007) (access to a remote video sensor device). Wu, et al., “Composable IO: A novel resource sharing platform in personal clouds,” Proceedings of 1st International Conference on Cloud Computing, (2009). All these systems and methods focus on remote access to peripheral 10 devices, while Peek, et al. “EnsemBlue: Integrating Distributed Storage and Consumer Electronics,” Proceedings of the 7th USENIX Symposium on Operating Systems Design and Implementation (OSDI) (November 2006) disclose a distributed file system for personal devices that store multimedia. Aspects of the disclosed subject matter of the present application, on the other hand, propose device sharing enabled using relationships between users in on-line social networks, encompassing all aspects of communication including authentication, naming, discovery and access control.

Utilizations of location-limited channels, such as an infrared link, USB key, gestures (touching the two devices together), etc. have been proposed to authenticate ad-hoc devices, such as is discussed in Balfanz et al., “Talking to strangers: authentication in ad-hoc wireless networks” Proceedings of Network and Distributed System Security Symposium (NDSS) (2002) (Balfanz I). Balfanz et al., “Network-in-a-box: How to set up a secure wireless network in under a minute,” Proceedings of the Usenix Security Symposium (2004) introduced the idea of performing user-friendly wireless authentication by making use of location-limited channels. Asokan, et al., “Visitor access management in personal wireless networks,” Proceedings of the Seventh IEEE International Symposium on Multimedia,” propose a way to manage access control for visitors to a personal wireless network. Dourish, et al., Security in the wild: User strategies for managing security as an everyday, practical problem,” Personal and Ubiquitous Computing, 8(6), pp. 391-401 (2004) highlighted the importance of usability in designing secure systems. Wi-Fi Protected Setup (WPS), http://www.wi-fi.org/wifiprotected-setup/discusses a standard that was established by the Wi-Fi Alliance for easy and secure establishment of a wireless network, by automatically setting up keys.

Social network sites are commonly used by applications to bootstrap their own authenticated communication channels. Ramachandran, et al., “Authenticated out of band communication over social links,” Proceedings of the First ACM SIGCOMM Workshop on Online Social Networks (2008) proposed a framework that allows applications to authenticate and discover peers using social networking sites. The majority of large social networks today support such a functionality, as discussed in OpenID Foundation. http://openid.net/ (Google's OpenSocial) and http://developers.facebook.com/connect.php. (Facebook Connect), utilizing application programming interfaces (“APIs”) for web-based social network applications that aim to make applications social networking enabled by letting users bring their identity and connections everywhere. OpenID, as discussed in http://openid.net/. is an open, decentralized standard for authenticating users which can be used for access control, allowing users to log on to different services with the same digital identity where these services trust the authentication body. However, thus far, the social network art has only been proposed as an out-of-band authentication and peer discovery channel for users and applications.

It has been proposed, e.g., in Tootoonchian, et al., “Better privacy for social networks,” Proceedings of the Fifth ACM International Conference on Emerging Networking Experiments and Technologies (CoNEXT) (2009) and Puttaswamy, et al., “Preserving privacy in location-based mobile social applications,” Proceedings of Hot-Mobile Workshop (2010) to use a social network as a encrypted data store, and storing user keys in the social network, addressing the goal of protecting user privacy when users share states in a social network, as opposed to the disclosed subject matter relating to enabling device sharing by making use of a social network.

There are. therefore, many improvements that can be made in this nascent and growing technology of sharing over social networks. The currently ubiquitous use of personal devices can be made to include more seamless sharing, e.g., with less need for support for authentication, access control, device naming and discovery and like requirements.

### SUMMARY OF THE INVENTION

A system and method is disclosed which comprises receiving, via a computing device, from a first user having a first personal device, a request for sharing access to one of a resource and a state of a second personal device of a second user, the first user having an on-line social network relationship with the second user on an on-line social network; and determining, via the computing device, whether to grant sharing access to the one of the resource and the state of the second personal device of the second user. Determining whether to grant sharing access may be based, at least in part, upon the nature of the on-line social network relationship between the first user and the second user. The method and apparatus may comprise registering, via the computing device, an ownership link for a personal device and an owner having a certified identity within the social network; storing the ownership link; and utilizing the ownership link for determining whether to grant sharing access.

The system and method may comprise assigning, while registering, a persistent personal name to the registered personal device, distinct from a personal device network address, that is, e.g., other than a network universal resource locator (“URL”), but rather the on-line social network identifying user name, as an example, thus, the persistent personal name may correspond to the on-line social network user name associated with a certified identity of the user of the personal device. The system and method may comprise setting, via the computing device, at least one access control rule for one of a resource and a state of the personal device of the second user.

The system and method may further comprise the at least one resource comprising one of an Internet connectivity and a phone calling plan, such as, e.g., talktime, of the second personal device used by the first personal device without the need for real time human intervention. i.e., the linking for sharing is done by the computing device of a system implementing the method. The system and method may also comprise a personal device of the second user registered on the on-line social network being searched by the first personal device of the first user, at least in part based on the on-line social network relationship established between the first user and the second user in the on-line social network.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 shows a social graph of users extended with their personal devices. some of which may be connected to the Internet, according to aspects of an embodiment of the disclosed subject matter;

FIG. 2 shows SBone as an overlay network of users and their personal devices, with SBone mapping to a social network of users, to infer inter-personal relationships among them, according to aspects of an embodiment of the disclosed subject matter;

FIG. 3 shows a magnified view of a user on SBone with personal devices of the user, according to aspects of an embodiment of the disclosed subject matter;

FIG. 4 illustrates a possible architecture where owners 12 of devices 14 (A and B as illustrated) are friends, where device A has a sharable internet resource and SBone 30 enables device B to get connected to the internet using device A's connectivity, according to aspects of an embodiment of the disclosed subject matter;

FIG. 5 shows personal devices 14 sharing state information with each other, according to aspects of an embodiment of the disclosed subject matter;

FIG. 6 shows an example of an SBone system including an SBone server, an SBone client and an SBone Facebook application, according to aspects of an embodiment of the disclosed subject matter; and,

FIG. 7 shows an example of a graphical user interface (“GUI”) for an SBone Facebook application, where, e.g., users can see the on-line status of their personal device(s), and the personal device(s) owned by a user friend(s), according to aspects of an embodiment of the disclosed subject matter.

### DETAILED DESCRIPTION OF THE PREFERRED EMBODIMENTS

The above noted phenomenon of sharing between and among friends can be extended to the personal devices being used. On these personal devices, owners can store personal data, such as contacts, experiences, songs, pictures and videos, and like information. These personal devices are also capable of sensing environmental information, such as location, commercial and on-line transactions, traffic, temperature, etc., which might be useful to provide participatory sensing, such as is discussed in Burke, et al., “Participatory sensing,” Proceedings of World Sensor Web Workshop, ACM Sensys (2006). The state of these devices, such as ring status (vibrate, silent or normal) can help friends to decide when to call, to text or to send mail, and the like. In addition to stored data and state, personal devices also have resources such as internet connectivity, GPS, camera, and talktime, which, today, are available only to their owners. However, owners may want to share these resources with their friends. For example, the owner of a personal device with internet access may want to share the internet connection with a personal device(s) owned by a friend(s), e.g., who is in the same vicinity, such as in a shopping mall, or has common interests, or the like.

According to aspects of embodiments of the disclosed subject matter, a system and method is disclosed which applicants have denominated “SBone,” an architecture that can facilitate sharing of resources and capabilities offered by personal devices among people who are connected, e.g., friends connected through a social network. SBone can be used to establish trusted connections between devices by leveraging the relationships that already exist between their owners, e.g., in the on-line social network.

According to aspects of embodiments of the disclosed subject matter, the existence of inter-personal trusted relationships can provide a backbone for personal device sharing. By linking devices with users who own and carry them, it is possible to provide better usability, security and trust. Social networks, and the like associations of on-line users, can provide a natural way to connect personal devices of friends. This established connection is useful in curating signals from personal devices in conjunction with the social signals from the already established links among people in online social networks. An increasingly vast majority of people who own personal devices are connected to each other by social networks. Facebook, as an example, reports more than 400 million active users, of which more than 100 million currently access Facebook through their personal devices, including mobile personal devices. On-line social networks have become an extremely popular way for people to maintain on-line identities and trust relationships in the form of links to friends and the like. These social links between users are an alluring asset, which applicants here propose to leverage to provide authentication, naming, discovery and access control between the personal devices, including portable personal devices.

Using SBone, according to aspects of embodiments of the disclosed subject matter, users can add their devices to the system in a secure manner, and specify access control policies for their friends to share the state, capabilities, resources and the like of these personal devices. A friend's device can read the state of the device that belongs to another friend, family member, colleague, or an acquaintance connected by SBONE. Based on this state, the device can choose to take the appropriate action. If a friend's phone is in silent mode or indicates it is in a location pertaining to a meeting room, then the caller of this friend can be postpone calling or send a message instead so as not to disturb the callee. Personal devices can be assigned personal names, and the users can query the system for devices based on personal names or other attributes and relationships. Providing these features in a scalable and secure way according to the disclosed subject matter can create ways to address challenges in authentication, access control, naming and discovery of devices.

SBone can be used to enable Internet sharing between mobile personal devices. Personal devices, including also phones, laptops, PDAs and other wireless access points, typically can have a desired resource, such as internet connectivity, by means of WiFi. 3G, or 4G interfaces. On the other hand, other personal devices such as phones without a 3G subscription, IPods, TiVo players, and the like, typically do not possess internet connectivity, though they can communicate with other personal devices that do have the internet connectivity resource, though not over the internet. SBone has been shown to allow devices with a desired resource, such as an internet connectivity resource, to share that resource with other personal devices, e.g., through the social network. Once one personal device is connected, e.g., to the social network, other personal devices can find the one personal device by querying to or through the social network.

In one aspect, a method implemented utilizing a computing device, such as a server, can include receiving, by the computing device and from a first user having a first personal device, a request to access a resource or state of a second personal device of a second user having a relationship with the first user on or through a social network. Access control rules and policies can be applied, by the computing device, with respect to the second user to permit, manage and implement an access of the resource or state of the personal device of the second user by or through the personal device of the first user. In one embodiment, the computing device can register the first user, such as by registration of the first user or the personal device of the first user and the second user, such as by registration of the second user or the personal device of the second user, e.g., for participation in an SBone system and method, e.g., as part of a registration to participate in the social network or some supplement to such social network registration.

In one embodiment, the computing device can receive from the personal device of a second user the access control policy. The access control policy can, e.g., specify which other personal devices of other users that have a relationship with the second user in or through the social network can access a capability, resource or state of the personal device of the second user.

As discussed herein applicants propose an SBone architecture and design for resource and state sharing, such as, Internet resource sharing between personal devices using SBone.

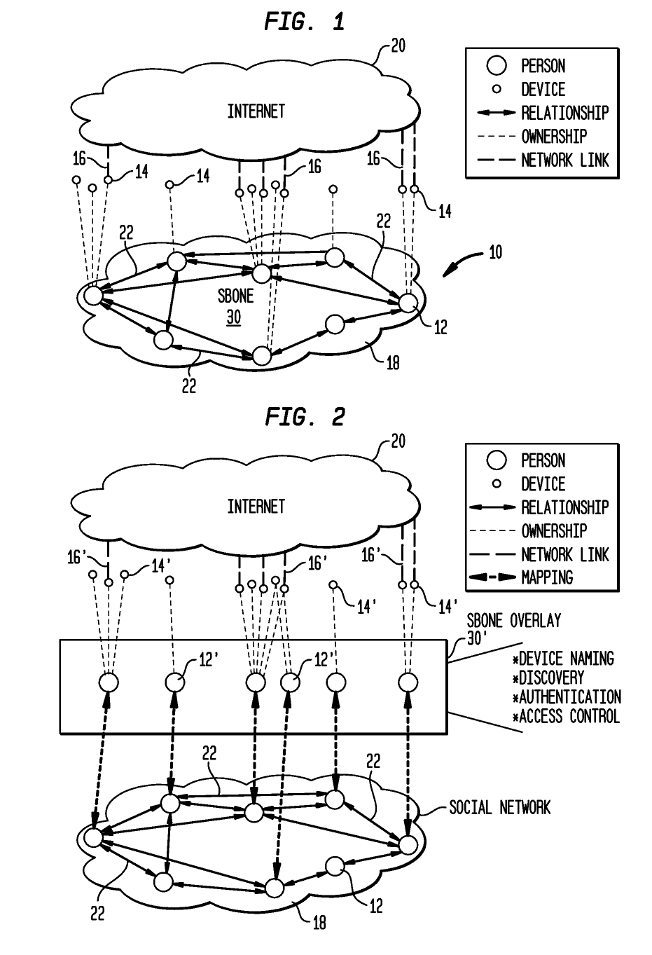

Turning now to FIG. 1 there is shown a social graph 10 of users 12, i.e. persons, in a social network 18, with their personal devices 14, some of which may be connected to the Internet 20, as illustrated by the dashed lines 16. FIG. 2 illustrates SBone 30 as an overlay network 30′ of users 12′ and their personal devices 14′, with the SBone overlay network 30′ mapping to a social network 18 of users 12, with inferred inter-personal relationships 22 among them. In the embodiment of FIG. 2, the SBone 30 model and system architecture, in relation to the personal devices 14 and users 12 who own them, shows connections 22 between users 12, representing a social relationship between the respective user(s) 12. Personal devices 14 can be connected to their owners by means of ownership links. Finally, some personal devices are connected (dashed lines 16) to the Internet 20, which is seen as a resource they can share, e.g., with other personal devices 14 which are not so connected.

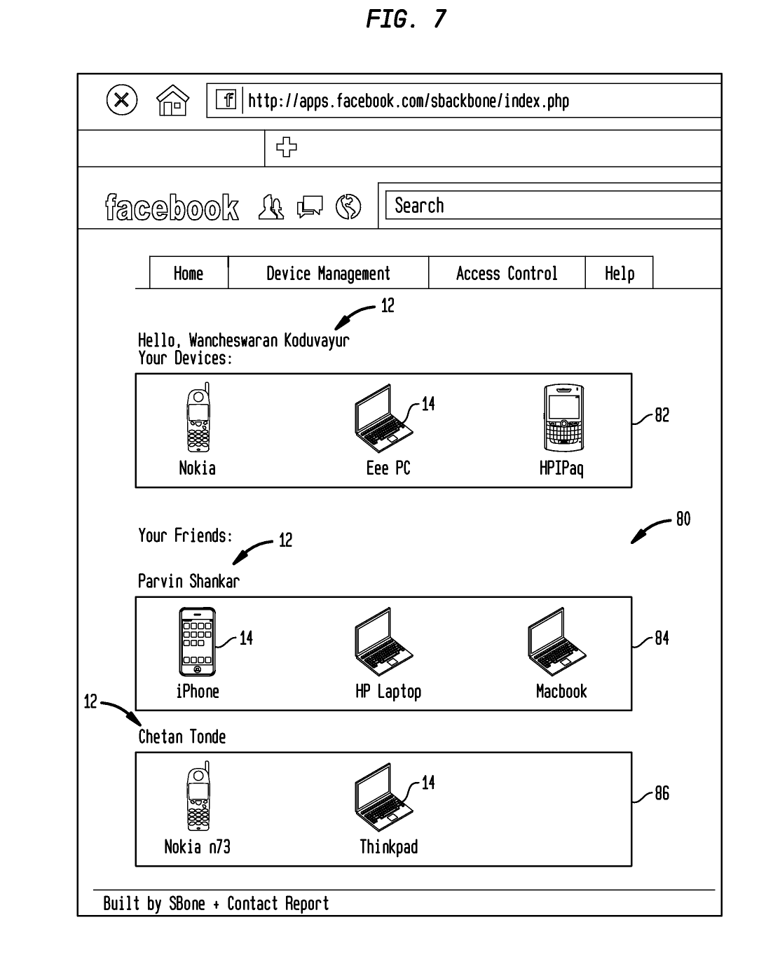

The SBone 30 architecture can realize this model by creating an overlay network 30′ of users 16′ and personal devices 14′ on top of a social network 18, as shown in FIG. 2. This overlay network 30′, which connects to an on-line social network 18, and performs device naming, discovery, authentication and access control, is herein referred to as an SBone server 40, shown in FIG. 7.

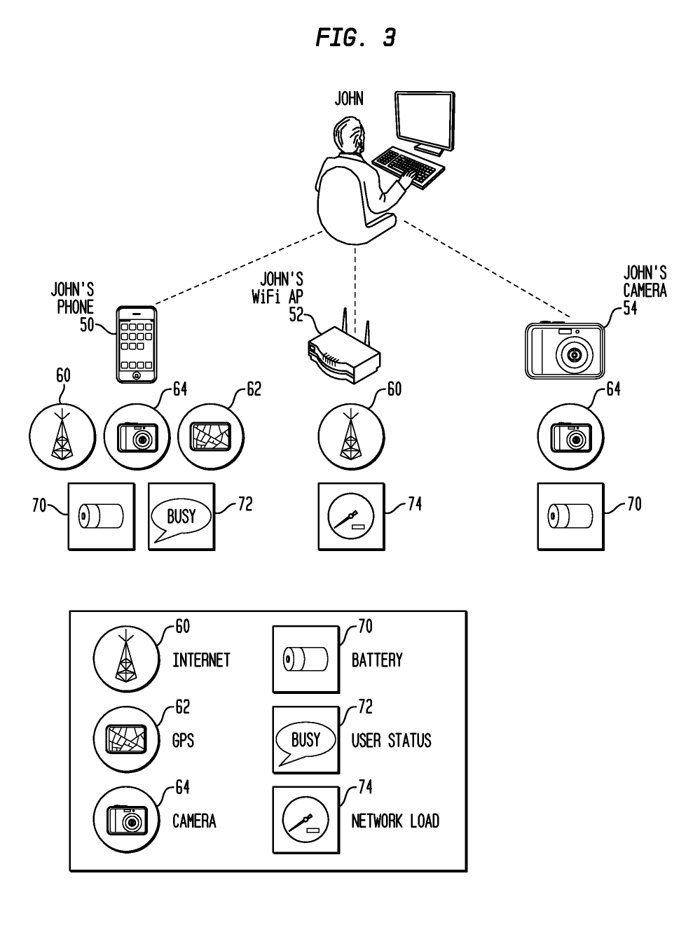

Turning now to FIG. 3, there is shown the devices that the user 12, John, owns, such as a phone 50, a WiFi application 52 and a digital camera 56. Each device 14 can bee seen to have a set of resources/capabilities, illustrated in circles, such as internet connectivity 60, global positioning system (“GPS”) 62 and digital photography 64, along with state information, as illustrated in squares, such as, battery 72, user ring status 74 and network loading 76.

Each personal device 12 has a set of resources, such as 60, 62, 64 and state information 70, 72 and 74. An embodiment of the set of resources and state information of personal devices 14 is shown in FIG. 3. Examples of resources that devices, as noted above, may share include internet connectivity 60, GPS 62 and digital photography 74, along with, e.g., talktime (not shown). The state of a device 14, such as 70, 72 and 74, by way of example, can be either device-specific (such as battery 72, ring status 74) or environment-specific (such as traffic, temperature, not shown). This state, such as 70, 72, 74, can be useful to other devices 14, and can be shared.

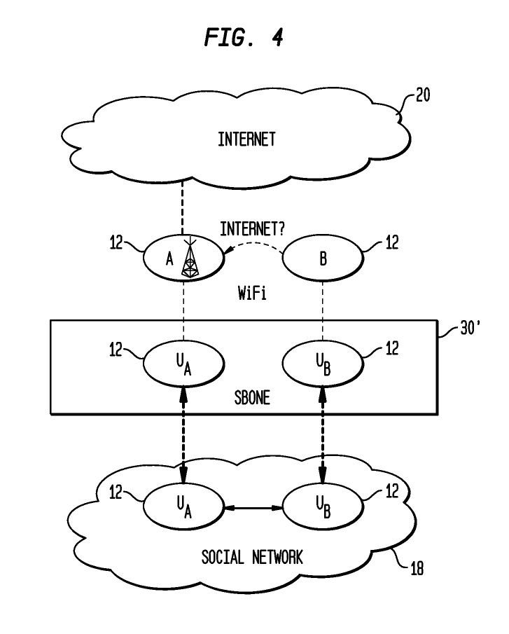

FIG. 4 illustrates a possible architecture where owners 12 of devices 14 (A and B as illustrated) are friends, where device A has a sharable internet resource and SBone 30 enables device B to get connected to the internet using device A's connectivity. In an embodiment of SBone 30 personal device 14 sharing lifecycle can include phases, such as three phases: registration, connection and resource/state sharing. Registration can establish the ownership link for a new device 14 that is to be added to SBone 30. In one embodiment, the connection phase occurs when an SBone 30 device 14 attempts to connect to a network (e.g., the Internet 20). In one embodiment, a connected device 14 enters the sharing phase whenever the sharing phase is available. In one embodiment, registering a new device 14 to SBone 30 links the new device 14 to its owner 12 and assigns the new device 14 a persistent personal name. The user 12 may then set access control policy for the resources, such as 60, 62, 64 and states, such as 70, 72 and 74 for this device 14.

In one embodiment, device 14 can look continuously to connect to a network (e.g., the Internet 20) using either the user's own network link 60, or a network link of a device 14 of a user friend 12 that is willing to share the internet resource 60 of the personal device 14 of the user friend 12. On finding the latter, the two devices 14 can securely pair with each other using the SBone overlay 30′. Once a device 14 connects to the Internet 20, the device can be assigned a routable name, which can be used by other devices 14 to reach it.

In one embodiment, personal devices 14 can discover available resources, such as 60, 62, 64, offered by other devices 14 in the SBone overlay 30′, e.g., using queries based on, e.g., social network 18 relationships and attributes. In one embodiment, once devices 14 find each other, secure device-to-device pairing occurs. Unlike the traditional definition of pairing, in one embodiment, device-to-device pairing in the SBone overlay 30′ refers not only to near-field communication, but also to the case when the devices communicate to themselves or other devices 14 via the Internet 20.

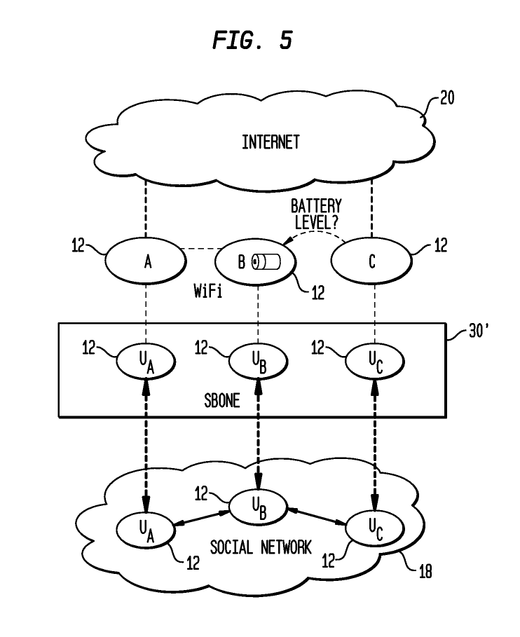

An embodiment of resource and state sharing in SBone 30 is illustrated in FIGS. 4 and 5, respectively. In the example shown in FIG. 4, device A has a sharable internet resource. Devices A and B allow resource sharing between each other, since their respective owners 12 are connected to each other by a social relationship 22. The social network connections 22 exist between the users 12 (UA and UB) in the social network 18, and such connections 22′ also exist in the SBone overlay 30;′ this enables device B to get connected to the Internet 20 using device A's internet resource 60. Devices 14 can also share state information with each other, as illustrated in FIG. 5. Suppose device C wants to know the battery level of device B in order to decide whether to call, text or send mail. Since UB and UC are friends, connected in the social network 18 by a connection 22, which connection exists also in the SBase overlay 30′ as connections 22′, the two devices 14 are paired, and the SBone overlay 30′ enables device C to check device B's battery state.

In one embodiment, the first step in an SBone 30 device 14 carrying out sharing is to introduce a new device 14 to the SBone 30 network by registering the new device 14 to one or more social networks 18 to which the user 12 belongs. The system can verify that the user 12 owns the device 14. Systems that support mobile clients typically make use of a trusted out-of-band authentication channel, such as short message service (“SMS”), to allow the user 12 to prove that the user 12 possesses the device 14. However, not all devices 14 have the ability to send and/or receive SMSs. In one embodiment, location-limited channels, using defined protocol(s) to establish secure communication channels, such as are discussed in BalFanz I, such as wireless, bluetooth, infrared or USB, can be used to authenticate a device 14 and the owner 12 of the device 14. In one embodiment, for short-range communication, the social network cannot be used as an end point, so SBone 30 can allow the user 12 to delegate a desktop, laptop or smartphone, or the like as an authentication proxy.

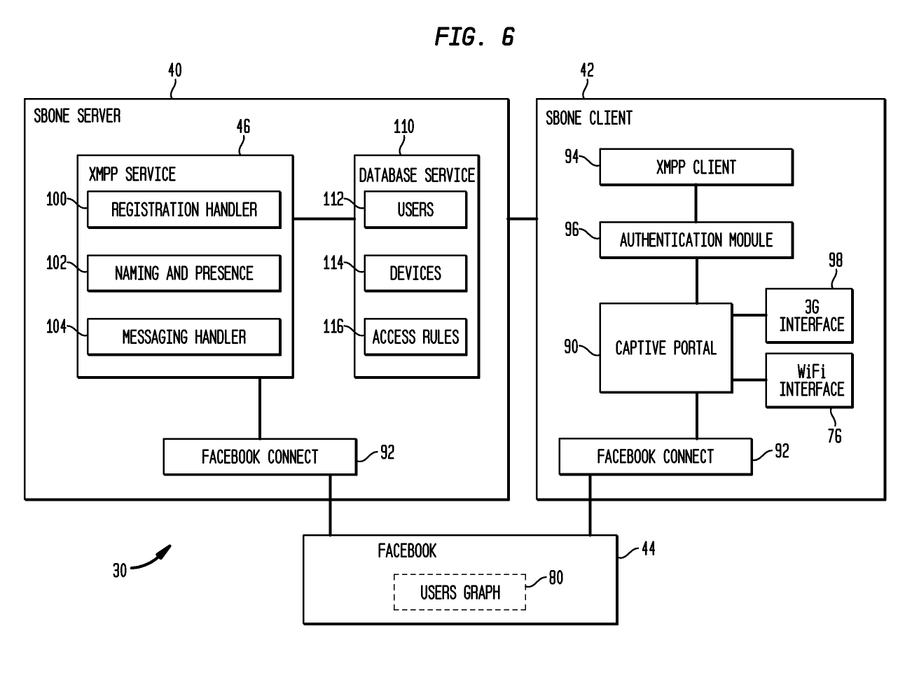

In one embodiment, once a device 14 is registered, it can generates a key pair and a public key certificate, sometimes referred to as a digital certificate or identity certificate, used in cryptography to bind the public key portion of a key pair to a user 12, which key pair can be stored in the newly added device 14. The public key of the device can then also be stored on the SBone server 40 (shown in FIG. 6), which can act as a certificate authority (“CA”). In other words, the SBone server is knowledgeable of the public key and private key for each user 12, having perhaps generated one or both, and keeps the private key securely in a secured server, not for public distribution, but only for distribution to the individual user by some secure communication method. The user can then use the private key to decrypt messages encrypted with the user's public key, distributed publicly to other users, and to encrypt messages to send to others that can then also be decrypted using the public key.

A user 12 may remove a device 14 from the system (say when the device is lost, or the user no longer wants to use it). SBone 30, therefore, has to also maintain a certificate revocation list (“CRL”). In one embodiment, devices 14 need to have connectivity with the SBone server 40 at all times in order to use a “CRL.” Devices owned by multiple users 12 can create a further challenge for the system. It is possible, e.g., that multiple members of a family can share a device 14. For simplicity, it is assumed that a single personal device cannot have multiple ownership links, i.e., it is presumed that there is only one registered owner, though in reality there may be more than one.

Once a personal device 14 is registered to the system, the user 12 can then specify that a device 14 of a user 12 friend devices can access the user's device 14 as to a specific resource, such as 60, 62, 64 and/or a specific state, such as 70, 72, 74 of the device 14 of the user 12. Specifying access control policy can involve a trade-off between flexibility and usability. In one embodiment, an all-or-nothing policy can be adopted. However, the problem with such an approach is that, other users 12 do not have the same level of trust with all their user 12 friends, such as virtual friends in a social network 18. A user 12 friend in a social network 18 can refer to an acquaintance or an acquaintance of a friend or acquaintance, a present or former co-worker, a close friend or previous close friend, or a relative, including a sibling or a spouse. In another embodiment, a fine-grained access control is hard to specify for an average user 12. Typical users in a social network 18 have many friends (social connections), e.g., several hundred, and, as discussed in Sasse, et al., “Transforming the weakest link a human/computer interaction approach to usable and effective security” Proceedings of BT Technology Journal, 19 (3), pp. 122-131 (2001) users 12 may have a difficult time in making complex security decisions.

In one embodiment, the social network can be represented as a hypergraph, where each edge represents a relationship, such as friend, close friend, family member, sibling, co-worker, etc. Access control policy in SBone 30 can then be specified per user, in the form of a matrix, where, e.g., the rows are the resources vectors and state vectors, and the columns are the relationships. A typical user 12 may have only a limited number of relationship edges of which the user 12 is a part. This way, the number of rules that need to be specified for each device 14 associated with a particular user 12 may be able to be limited to a more manageable number. Relationships can in some embodiments also inherit other relationships. For example, the close friend relationship can inherits the simple friend relationship, and the sibling relationship can inherits the relative/family member relationship. Users can define a precedence order among relationships, which can then be used between users who are connected to each other by multiple relationship types.

In one embodiment, there can be two steps in the connection policy specification process: first, forming a relationship hypergraph, and second, specifying access control rules. The first step may be performed each time a new friendship link is created in the social network. The second step may be performed whenever a user 12 adds a new personal device 14. That is, the relationship hypergraph may be relationship driven and the access control rules may be personal device driven.

To form a relationship hypergraph, the system needs to understand the semantic meaning of an edge between users 12 in a social network 18. In one embodiment, this can be accomplished using, e.g., a combination of automated and manual techniques. In one embodiment, the system can, e.g., mine the interactions 22 in the social network 18 to infer inter-personal relationships. In one embodiment, the system can present the inferred relationship hypergraph to a user 12, and user 12 can correct mistakes made by the system, or simply change a relationship designation(s).

In one embodiment, SBone 30 can identify for each personal device 14 by using a personal name, e.g., that is specified by the owner/user 12 when registering the device 14. This name may be a unique specifier within the device 14 namespace of the user 12, such as a user social network name, nickname, personal identifier, etc., or combination of these, that is used to identify the user 12, e.g., in the social network 18. Sbone 30 can use, e.g., the combination of a user 12 name and a personal device 14 name to arrive at a globally unique personal name for every device 14. FIG. 3 illustrates an example of an embodiment of the device namespace for a user 12 “John.”

The personal name for a personal device 14 can be persistent, and can be used to identify the device 14, but in one embodiment the personal name of the device 14 cannot be used to initiate communication to the device 14. In such cases, e.g., each time the device 14 is connected, SBone 30 can map the personal name to a routable address for the personal device 14. An SBone server 40 client, running on the device 14, can then connect to the SBone server 40, and specify this mapping.

If a device 14 is connected to the Internet 20 directly, this mapping can be done trivially. However, most devices 14 are part of, e.g., a home or an enterprise network, and often behind a Network Address Translator (NAT), which can make it difficult for other personal devices 14 to initiate a connection to these networked personal devices 14. A similar situation can be faced by voice over Internet protocol (“VOIP”) personal devices 14, e.g., also inside home or enterprise networks. In one embodiment, a STUN/TURN server, as is discussed in Rosenberg, et al., “Traversal Using Relays around NAT (TURN), Internet-Draft and Rosenberg, et al., “Session Traversal Utilities for NAT (STUN), RFC 5389, can be used to address this problem, e.g., by discovering the external IP address and port, which can be used to allow direct incoming connections, i.e., a relay server which can relay messages if the personal device is behind an Enterprise NAT.

In one embodiment, users 12 can access a personal device namespace of a user friend(s) 12, and browse the personal device 14 of a user friend 12. Users 12 can also see what resources, e.g., 60, 62, 64, each personal device 14 of a user friend 12 has, and its state vector, e.g., 70, 72, 74 subject to the access control policy. In addition to manual browsing, in one embodiment a query interface may be used. This query interface may be used because, for example, the number of user friends 12 a typical user 12 has is on the order of hundreds and the personal devices 12 may seek to directly discover each other without human intervention. In one embodiment, SBone 30 can support a query interface to find other personal devices 14.

A query can be formed using different attributes, such as to find personal devices 14 that have a particular internet resource, such as 60, 62, 64 and are within a certain distance, such as within some number of miles of the user 12 personal device 14. Queries can also be based on relationship, such as to find personal devices 14 owned by a college friend or a current co-worker or the like. In one embodiment, a relationship may also be used for ranking query results. This may rely, e.g., on a defined relationship within the social network as a measure of trust that the user 12 has. Given the choice, a user 12 could normally prefer sharing the resource, e.g., 60, 62, 64 of a personal device 14 that belongs to a more trusted person 14, as defined by the particular relationship, such as a direct family member. Even if a user 12 does not specify a relationship explicitly, the SBone server 40, as an example, can rank query results based on relationship definitions/levels of likely trust, etc.

OSNs can have hundreds of millions of users 12, and each user 12 can have many personal devices 14. An underlying database querying interface may scale to this large number of devices. Distributed databases such as Cassandra, as discussed in “The apache cassandra project,” http://incubator.apache.org/cassandra/ can support transparent scaling. A graph database such as Neo4J, as discussed in neo4j. http://neo4j.org/ is optimized to more rapidly perform queries involving native graph operations. Depending on the type of query, schema-free relational databases and graph databases may be used.

In one embodiment, once two personal devices 14 find each other, the personal devices 14 can perform secure pairing. Unlike the traditional definition of pairing, device-to-device pairing in SBone 30 can relate not only to near-field communication, but also to the case when the personal devices 14 communicate via the Internet. Personal devices can exchange their public key certificates with each other. SBone 30 can use the public keys stored in the SBone server 40 to perform such device-to-device pairing, such as by sending encrypted messages to the respective personal device 14 using the public key of the respective personal device 14, and providing the public key of one personal device 14 to the other and vice versa, or communicating with each such personal device with the public key of the respective personal device 14 and using the public key of the other personal device 14 in the pair to establish the pairing.

SBone 30 can enables users 12 to share the state information, such as 70, 72, 74, of their personal devices 14 with their user friends 12. If the resource, such as 60, 62, 64, of a personal device 14 is a popular one, repeated queries may place undue strain on the resources of the device 14. Personal devices 14 may have limited battery or communication bandwidth or the like. When repeated queries are placed on a personal device 14, the results of the query may be stored, such as by being cached on the SBone server 40. SBone 30 can maintain a staleness indication to indicate how fresh the state information is, using, for example, the last updated timestamp.

SBone 30 can enable a user 12 to share the resources, such as of the personal device 14 of the user 12, such as internet connectivity 60, GPS 62, camera 64, and talktime, with a personal device 14 belonging to a user friend 12. Some resources, such as 60, 62, 64, can be used simultaneously by multiple users 12, such as internet connection 60. Other resources, such as 60, 62, 64, can be used by only one user 12 at a time, such as talk time. For users to share their resources with others, several user 12 concerns need to be addressed. When the owner 12 wants to use the sharable resource, SBone 30 can implement a Quality of Service (QoS) mechanism that can allow, e.g., the user 12 to control the level of sharing. In the case of a resource that cannot be simultaneously accessed by multiple users, SBone 30 can implement a scheduling scheme to determine which user 12 can reserve which resource during, e.g., which time period. Time periods may be imperceptible to human detection, such as when multiple accessing coding of some form is used, including time division multiple access (“TDMA”) with very short time divisions, code division multiple access, (“CDMA”) or frequency division multiple access (“FDMA”) as available. In one embodiment, not all users 12 may be altruistic in sharing. Some users 121 may require an incentive model to encourage them to share their resources. To implement an incentive mechanism, SBone 30 may can have an accounting component that logs the resource usage.

In one embodiment, the owner can control the level of sharing of a resource, such as 60, 62, 64. When the owner accesses the shared resource, SBone 30 can give priority to the owner. Further, in one embodiment the owner can have the ability to temporarily disable sharing for a resource, whenever the owner wants sole access to the resource. In one embodiment, if a resource, such as 60, 62, 64 cannot be simultaneously accessed by multiple personal devices 14, other user friends 12 need to have a mechanism with which they can reserve access to the resource. A scheduler running on the personal device 14 of the user 12, or on SBase 30 can be used to ensure that a reservation is followed. In one embodiment, the owner 12 also may be required to abide by a reservation. In one embodiment, an accounting module (not shown) can log the resource usage so that, optionally, a billing scheme can be incorporated. Different metrics can be used, such as time of usage, or a resource specific metric (like bytes downloaded for an internet resource 60, or pictures taken for a camera resource 64).

Turning now to FIG. 6 there is shown an example of an SBone system 30 including an SBone server 40, an SBone client 42 and an SBone Facebook application 44, as illustrated in further detail in FIG. 7 showing an example of a graphical user interface (“GUI”) for the SBone Facebook application 44, where, e.g., users 12 can see the on-line status of their personal device(s) 14, and the personal device(s) 14 owned by a user friend(s) 12. The SBone server 40 can be utilized to manage the system 30, such as the functions of registration, naming and discovery. The SBone client 42 can perform such functions as personal device 14 sharing and lifecycle, e.g., consisting of the registration, connection and sharing phases. The social network application 44 can be used for authentication and access control.

In one embodiment, the SBone server 40 can maintain a network of users and devices using an Extensible Messaging and Presence Protocol (XMPP) service 46, such as is discussed in “XMPP protocol specification,” http://xmpp.org/tech/overview.shtml. An XMPP service 44 can form an open, XML-based protocol for message-oriented middleware such as Instant Messaging (“IM”), Voice Over IP (“VOIP”) and file transfer signaling. Popular deployments like Google's GTalk have demonstrated the scalability of an XMPP service 46. Due to, e.g., the use of XML, the protocol is extensible. In one embodiment, Jabberd2 can be as the open-source XMPP server 46. In one embodiment, the SBone server 40 can store the user 12 and personal device 14 information in a Mysq1 database, such as in database service 48 which can be accessed by the SBase XMPP server 40.

In one embodiment, the SBone client(s) 42 can run an XMPP client, which can, e.g., register to the SBone server 40 using unique identification information, e.g., the Facebook credential(s) of the owner 12. After registration, the SBone client 42 can connect to the SBone server 40 and send the routable name of the personal device 14 of the owner 12 to the SBone server 40, which can allow other clients 42 to reach the newly registered personal device 14. The personal device 14, now registered as a client 42 can also send its list of shared resources to the SBone server 40.

In one embodiment, a social network application used can be Facebook. The SBone social network application 44 can allow a user(s) 12 to visualize the network for the owner 12 personal device 14. FIG. 7 shows an embodiment of a screenshot of a graphical user interface 80 of the SBone Facebook application 44. A user(s) 12 can see the list 82 of personal devices 14 owned by the user 12 and lists 84, 86 of personal devices 14 owned by a respective user friend 12. A personal device 14 that is currently connected to the Internet 20 can be displayed as online. Users 12 can send a message(s) to a personal device(s) using this graphical user interface 80. A personal device(s) 14 can also directly send a message(s) to another personal device(s). The XMPP protocol, as an example, can supports XML messages, so the SBase server 40 can be extended to share pictures, audio, video and the like data.

In one embodiment, SBone 30 can be implemented that allows mobile personal devices 14 to connect to the Internet 20 using an internet resource 60 of a personal device 14 of a user friend 12. The scenario corresponds to FIG. 4, where the client devices A and B can be, e.g., Linux laptops, the SBone server 40 can be a Linux server, and the on-line social network can be Facebook. In this example, personal device 14 A has a sharable Internet resource 60, and personal device 14 B can get connected to the Internet 20 using personal device 14 A's connectivity.

In one embodiment, Internet connectivity resource sharing functionality 60 can be implemented between personal devices 14 A and B, as described in FIG. 4, using the SBone server 40. A can be a Linux laptop running as an SBone client 42 with a WiFi interface 76, as seen in FIG. 6, set up as an access point, to provide Internet connectivity 60 sharing with a personal device(s) 14 owned by an owner friend 12 in the same social network. In one embodiment, Internet connectivity sharing can be implemented using a captive portal 90, also shown in FIG. 6, which can be built using IPtables. The captive portal 90 can intercept normal network traffic from a portable device 14 of a user 12, such as newly associated wireless client, personal device 14 B, and diverts it to a website where personal device 4 B can be authenticated. Using IPtables filtering rules, IP traffic can be diverted to a web application running on personal device 14 A.

In one embodiment, for authentication, the captive portal 90 can use Facebook Connect 92, as is discussed in Facebook Connect. http://developers.facebook.com/connect.php. Facebook Connect 92 is a set of APIs provided by Facebook, which allow a Facebook user 12 to log-in to the SBone server 40, e.g., as an external website, using Facebook credentials. In one embodiment, once authenticated, the identity of the user 12 and the identity of social connections of the user 12 can be made available to the SBone server 4 (perhaps requiring the consent of the user 12 and/or user friends 12 of the user 12). Once B logs in, the SBase server 40 can retrieve UB's Facebook friends list. If UA and UB are related in Facebook as friends, the SBone server 40 can grant access to user 12 B by adding an exception in the filtering rules of user 12 A.

A system, as shown in FIG. 6, according to aspects of an embodiment of the disclosed subject matter may include the SBone server 40 and the SBone client 42. The SBone server 40 may include a registration handler module 100, to perform registration functionalities as discussed above, a naming and presence module 102 and a messaging handler module 104. The SBone server 40 may also include a database service 110 which may store, among other data, a user information data section 112, storing information identifying users 12, a devices information data section 114, storing data regarding personal devices 14 and a access rules section 116, which may be used to store information regarding access rules to be applied in instances of requested sharing and access as discussed above.

The SBase client 42 may include an XMPP client 94 for use as discussed above, an authentication module 96, which may serve to

encrypt messaging as noted above as part of authentication, a 3G interface 98 for the captive portal 90, in addition to the WiFi interface 76, and also a FaceBook connect module 92.

Sociologists have studied human relationships, and the factors that influence sharing between humans. With the advent of social media, people have analyzed how users 12 share news and personal data with user friends 12 on social networks, such as on-line social networks. Given a set of personal devices 14, it can be important to study the structure of networks formed by sharing patterns of the owners 12 these personal devices 14. Once people start sharing states, such as 70, 72, 74 and resources, such as 60, 62 and 64, of their personal devices 14 with user friends 12, aspects of combinations of social networks and computer networks will be developed and examined.

Personal devices 14 can possess personal information about the owner user(s) 12, that the owner user(s) 12 may not wish to share with others. State sharing can leak personal information of an owner user 12 to an unintended user(s) 12. Even if the system 30 provides access control policies, a user(s) 12 may find it difficult to specify fine-grained access control for, e.g., the device state, such as 70, 72 and 74 of the personal device(s) 14 of the user(s) 12, and, even when so specifying, may be prone to making mistakes. Designing better and more usable privacy controls for social networks can be an important issue to address, which can become even more relevant as users 12 share state, such as 70, 72, 74, of personal device(s) 14 with each other. Simply inferring trust from a social relationship(s), e.g., in an OSN may not be adequate. Google Buzz contains an auto-follow feature, which can be used to infer that users 12 may want to share a personal state with frequent email contacts. This can raise privacy concerns, since frequent email contacts could still be such as co-workers or other people with whom a user 12 may not necessarily want to share a personal state. Thus it is apparent that privacy concerns have to be addressed for people to share personal state(s), e.g. of their personal devices 14.

As an example of an approach to take, not all users 12 may be altruistic in sharing their resources with friends. Some users 12 may require an incentive model to encourage them to share their resources, such as 60, 62, 64. Moreover, in the case of resources that also depend on a service provider's cooperation, such as internet access, or sharing talktime, the incentive model may need to also provide an incentive to the service provider as well. An embodiment of an internet resource 60 sharing application can make use of, as an example, an http captive portal 90 to authenticate a user(s) 12. This can work, e.g., for a typical home user(s) 12, but may not satisfy the security requirements of an enterprise setting, where wireless networks may require encryption. A commonly used enterprise wireless setup can consist of a WPA2 Enterprise mode, with 802.1x authentication using a RADIUS server. In one embodiment, the SBase server 40 can be enhanced to support enterprise settings, using a modified RADIUS server (not shown) that can use a social network to authenticate clients.

The SBone server 40 can leverage social relationships from any existing online social network. However, not all OSNs are the same. As an example, users 12 can use Facebook to connect with their user friends 12 and user acquaintances 12, whereas users 12 may use LinkedIn to connect with user professional 12 contacts. Celebrities or celebrity wannabe users 12 may use sites like Twitter or Facebook Pages to connect with their user followers and worshipers 12. A link between two users 12 can, therefore, indicate different levels of trust on different OSNs.

An architecture was described that allows personal devices to share their resources and states with each other, using a social network for authentication, naming, discovery and access control.

As used in this application the term “a computing device,” such as may form a part of a system or be utilized to perform method steps as part of a method, according to aspects of an embodiment of the disclosed subject matter for a system and method for sharing personal device uses and states through a network such as an on-line social network, by way of example, may comprise a computer processor or other processor unit capable of obtaining, e.g., fetching, and executing instructions, such as application and operating system software instructions. The processor may be any form of hardware device for executing software instructions which may be stored in and obtained from a storage medium, such as cache memory, main memory, local disc storage and remote disc storage and may reside in different ones of such types of storage media at different times.

The processor may be any custom made or commercially available processor, a central processing unit (CPU), an auxiliary processor among several processors associated with the processing unit, a semiconductor based microprocessor (in the form of a microchip or chip set), a macroprocessor, a microcontroller, an array of processors, a networked group or array of computing devices or generally any device or combination of devices for executing software instructions. The processor may comprise a controller, microcontroller, or a hard wired, including firmware, device, or any combination thereof, or any other processor capable of performing logic driven operations, under the control of partly or fully programmable instructions.

Software operating on the processor may include one or more separate programs, each of which comprises an ordered listing of executable instructions for implementing logical functions. Software may be in the form of application software and operating system software which is stored in a tangible medium, such as any of the storage media (memories) noted above. The operating system essentially controls the execution of other computer programs by the computing device. Software may be written and compiled as (a) an object oriented programming language, which has classes of data and methods, or (b) a procedure programming language, which has routines, subroutines, and/or functions, such as C, C++, Pascal, Basic, Fortran, Cobol, Perl, Java, and Ada or standard Internet languages, such as XML or HTML.

In the context of this disclosure, a tangible computer readable medium may be any electronic, magnetic, optical, or other physical device or means that can contain or store data or a computer program(s) for use by or in connection with a computing device related system or method, and excludes merely transitory signals being propagated unassociated with any tangible computer readable medium, such as defined herein, which shall include a meaning of a non-transitory computer readable medium. The tangible computer readable medium can be, for example, but not limited to, an electronic, magnetic, optical, electromagnetic, infrared, or semiconductor system, apparatus, device, or other non-transitory propagation medium, including, by way of example an electrical connection (electronic) having one or more wires, a portable computer diskette (magnetic), a random access memory (RAM) (electronic), a read-only memory (ROM) (electronic), an erasable programmable read-only memory (EPROM), an electronically erasable programmable read only memory (“EEPROM”), a Flash memory (electronic), an optical fiber memory (optical), a portable compact disc read-only memory (CDROM) (optical), a tape (magnetic), a large disc storage medium (magnetic), etc.

For the purposes of this disclosure a module is a software, hardware, or firmware (or combinations thereof) system, process or functionality, or component thereof, that performs or facilitates the processes, features, and/or functions described herein (with or without human interaction or augmentation), as are described herein to be performed by a module. A module can include sub-modules. Software components of a module may be stored on one or more instantiations of a computer readable medium. Modules may be integral to one or more servers, or be loaded and executed by one or more servers. One or more modules may be grouped into an engine or an application.

The presently disclosed subject matter as described herein with reference to block diagrams and/or operational illustrations of methods and devices to perform methods according to aspects of an embodiment of the disclosed subject matter (collectively “block diagram”). It is understood that each block of the block diagram can be implemented by means of analog or digital hardware and computer program instructions, such as on a computing device. In some alternate implementations, the functions/acts noted in the blocks or steps can occur out of the order noted in the block diagram. For example, two blocks shown in succession can in fact be executed substantially concurrently, on the same processor or on different processors in parallel or the blocks can sometimes be executed in the reverse order, depending upon the functionality/acts involved.

For the purposes of this disclosure the term “server” will be understood to refer to a service point which provides processing, database, and communication facilities. By way of example, and not limitation, the term “server” can refer to a single physical processor with associated communications and data storage and database facilities, or it can refer to a networked or clustered complex of processors and associated network and storage devices, as well as operating software and one or more database systems, and applications software which support the services provided by the server, all of which may be also referred to as a computing device or a communication device as may be consistent with the context of the system and method being described or claimed.

Depending upon the context in which described or claimed a communication device may be more than one physical device operating to carry out the communication function described, such as any one of a number of hand held portable personal devices, such as, personal communications devices, such as, a cellular phone, Blackberry®, I-Pod™, Droid™, and the like, or groups thereof, interconnected to communications network stations and facilities, such as cellular phone base stations, the Internet, the public switched network, etc., any or all acting in series or in parallel or combinations thereof, with associated transmitting and receiving equipment, coding and decoding equipment, modulating and demodulating equipment, computing devices, data bases and the like equipment, necessary for and capable of, carrying out the disclosed or claimed communication referenced in the present application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments.

1. A method comprising:
receiving, via a computing device, from a first user having a first personal device, a request for sharing access to one of a resource and a state of a second personal device of a second user, the first user having an on-line social network relationship with the second user on an on-line social network; and
determining, via the computing device, whether to grant sharing access to the one of the resource and the state of the second personal device of the second user.

2. The method of claim 1 wherein determining whether to grant sharing access is based, at least in part, upon the nature of the on-line social network relationship between the first user and the second user.

3. The method of claim 2, wherein an application uses the granted shared access of the device state that belongs to the first user and the device state that belongs to the second user.

4. The method of claim 1 further comprising:
registering, via the computing device, an ownership link for a personal device and an owner having a certified identity within the social network;
storing the ownership link;
utilizing the ownership link for determining whether to grant sharing access.

5. The method of claim 2 further comprising:
registering, via the computing device, an ownership link for a registered personal device and an owner having a certified identity within the social network;
storing the ownership link;
utilizing the ownership link for determining whether to grant sharing access.

6. The method of claim 4 wherein registering comprises:
assigning a persistent personal name to the registered personal device, distinct from a personal device network address.

7. The method of claim 5 wherein registering comprises:
assigning a persistent personal name to the registered personal device, distinct from a personal device network address.

8. The method of claim 6 wherein the persistent personal name corresponds to an on-line social network user name associated with the certified identity.

9. The method of claim 7 wherein the persistent personal name corresponds to an on-line social network user name associated with the certified identity.

10. The method of claim 1 further comprising:
setting, via the computing device, at least one access control rule for one of a resource and a state of the personal device of the second user.

11. The method of claim 2 further comprising:
setting, via the computing device, at least one access control rule for one of a resource and a state of the personal device of the second user.

12. The method of claim 1, wherein the at least one resource comprises one of an Internet connectivity and a phone calling plan of the second personal device used by the first personal device without the need for real time human intervention.

13. The method of claim 1, wherein a personal device of the second user registered on the on-line social network is searched by the first personal device of the first user, at least in part based on the relationship established between the first user and the second user in the on-line social network.

14. A system comprising:
a computing device configured to receive from a first user having a first personal device, a request for sharing access to one of a resource and a state of a second personal device of a second user, the first user having an on-line social network relationship with the second user on an on-line social network; and
the computing device configured to determine whether to grant sharing access to the one of the resource and the state of the second personal device of the second user.

15. The system of claim 14 further comprising:
the computing device configured to determine whether to grant sharing access based, at least in part, upon the nature of the on-line social network relationship between the first user and the second user.

16. The system of claim 15, wherein an application uses the granted shared access of the device state that belongs to the first user and the device state that belongs to the second user.

17. The system of claim 14 further comprising:
the computing device configured to:
register an ownership link for a registered personal device and an owner having a certified identity within the social network;
store the ownership link; and
utilize the ownership link for determining whether to grant sharing access.

18. The system of claim 17 wherein the computing device is configured to register an assigned persistent personal name to the registered personal device, distinct from a personal device network address.

19. The system of claim 18 wherein the persistent personal name corresponds to an on-line social network user name associated with the certified identity.

20. The system of claim 14 further comprising:
the computing device configured to set at least one access control rule for one of the resource and the state of the personal device of the second user.

21. The system of claim 14, wherein the at least one resource comprises one of an Internet connectivity and a phone calling plan of the second personal device used by the first personal device without the need for real time human intervention.

22. A tangible non-transitory machine readable medium storing instructions, the instruction, when executed by a computing device, causing the computing device to perform a method comprising:
receiving from a first user having a first personal device, a request for sharing access to one of a resource and a state of a second personal device of a second user, the first user having an on-line social network relationship with the second user on an on-line social network; and
determining whether to grant sharing access to the one of the resource and the state of the second personal device of the second user at least in part based on the on-line social network relationship.
